(19) United States
(12) Patent Application Publication
(10) Pub. No.: US 2020/0137620 A1
(43) Pub. Date: Apr. 30, 2020

(54) WIRELESS COMMUNICATION SYSTEM AND METHOD FOR REDIRECTING MULTIMEDIA BROADCAST/MULTICAST SERVICE DATA

(71) Applicant: Institute For Information Industry, Taipei (TW)

(72) Inventors: Chun-Yen HSU, Taipei City (TW); Tzu-Ya WANG, Taipei City (TW)

(21) Appl. No.: 16/171,358

(22) Filed: Oct. 25, 2018

(51) Int. Cl. H04W 28/02; H04W 4/08; H04W 72/00

(52) U.S. Cl. CPC H04W 28/0289; H04W 28/0284; H04W 72/005; H04W 4/08

(57) ABSTRACT

A wireless communication system includes a broadcast/multicast service center, a first multimedia broadcast/multicast service (MBMS) subsystem and a second MBMS subsystem. The first MBMS subsystem includes a first MBMS core network coupled with the broadcast/multicast service center and a first base station coupled with the first MBMS core network. The second MBMS subsystem includes a second MBMS core network coupled with the broadcast/multicast service center and a second base station coupled with the second MBMS core network. The broadcast/multicast service center redirects MBMS data of a content provider which is transmitted from the broadcast/multicast service center to the first base station via the first MBMS core network to the second MBMS subsystem and the second MBMS subsystem forwards the MBMS data to the first base station, when the MBMS data is congested in the first MBMS subsystem.

### FIELD

The disclosure relates to a wireless communication system and a communication method. More particularly, the disclosure relates to a wireless communication system and a method for redirecting multimedia broadcast/multicast service (MBMS) data.

### BACKGROUND

FIG. 1 illustrates a schematic view of a conventional wireless communication system supporting MBMS. As shown in FIG. 1, the conventional wireless communication system 1 comprises a content provider CPD, a broadcast/multicast service center BM-SC_0, an MBMS core network CN_0 and a base station BS_0, wherein the MBMS core network CN_0 generally comprises an MBMS gateway, a mobility management entity (MME) and an MBMS coordination entity. The broadcast/multicast service center BM-SC_0 is coupled with each of the content provider CPD and the MBMS core network CN_0, and the MBMS core network CN_0 is coupled with the base station BS_0. There is a control plane signaling path between the content provider CPD and the base station BS_0 through the broadcast/multicast service center BM-SC_0 and the MBMS core network CN_0, for transmitting MBMS control signals. Similarly, there is a user plane path between the content provider CPD and the base station BS_0 through the broadcast/multicast service center BM-SC_0 and the MBMS core network CN_0, for transmitting MBMS data MD.

Normally, the base station BS_0 can receive the MBMS data MD which is provided by the content provider CPD on the user plane path, after the conventional wireless communication system 1 performs an MBMS signaling process on the control plane signaling path. However, the base station BS_0 may fail to receive the MBMS data MD when a traffic congestion takes place on the user plane path because of failure of wireless resource allocation, malfunctions of the conventional wireless communication system 1 or others. In this case, the wireless communication system 1 often suspends the transmission of the MBMS data MD until the traffic congestion is eased or overcome. Unfortunately, the suspension will degrade the transmission performance of the wireless communication system 1, and therefore, affect the MBMS quality to the user. In light of this, it is important to provide a better solution for the traffic congestion.

### SUMMARY

To solve at least the aforesaid problem, some embodiments of the present invention provide a wireless communication system. The wireless communication system may comprise a broadcast/multicast service center, a first multimedia broadcast/multicast service (MBMS) subsystem and a second MBMS subsystem. The broadcast/multicast service center may be coupled with a content provider. The first MBMS subsystem may comprise a first MBMS core network coupled with the broadcast/multicast service center and a first base station coupled with the first MBMS core network. The second MBMS subsystem may comprise a second MBMS core network coupled with the broadcast/multicast service center and a second base station coupled with the second MBMS core network. The broadcast/multicast service center may be configured to redirect MBMS data of the content provider which is transmitted from the broadcast/multicast service center to the first base station via the first MBMS core network to the second MBMS subsystem and the second MBMS subsystem may forward the MBMS data to the first base station, when the MBMS data is congested in the first MBMS subsystem.

To solve at least the aforesaid problem, some embodiments of the present invention provide a method for redirecting MBMS data in a wireless communication system. The wireless communication system may comprise a broadcast/multicast service center, a first MBMS subsystem and a second MBMS subsystem. The first MBMS subsystem may comprise a first base station and a first MBMS core network, and the second MBMS subsystem may comprise a second base station and a second MBMS core network. The method may comprise:

transmitting MBMS data of a content provider from the broadcast/multicast service center to the first base station via the first MBMS core network; and

redirecting the MBMS data to the second MBMS subsystem by the broadcast/multicast service center and forwarding the MBMS data to the first base station by the second MBMS subsystem, when the MBMS data is congested in the first MBMS subsystem.

To sum up, under the proposed wireless communication system, the broadcast/multicast service center can redirect the MBMS data originally designed to be transmitted to the first base station via the first MBMS core network to the second MBMS subsystem which can forward the MBMS data to the first base station instead of the first MBMS core network. Therefore, when the MBMS data is congested in the first MBMS subsystem, the first base station can still receive the MBMS data by the second MBMS subsystem without any suspension. In this way, the aforementioned problem can be resolved by the proposed wireless communication system.

The summary is not intended to limit the present invention, but merely describe the basic spirit of the present invention. Other features and advantages of the present invention will be more apparent to a person having ordinary skill in the art (PHOSITA) upon disclosures of the attached drawings and the following detailed description.

### BRIEF DESCRIPTION OF THE DRAWINGS

FIG. 1 illustrates a schematic view of a conventional wireless communication system supporting MBMS.

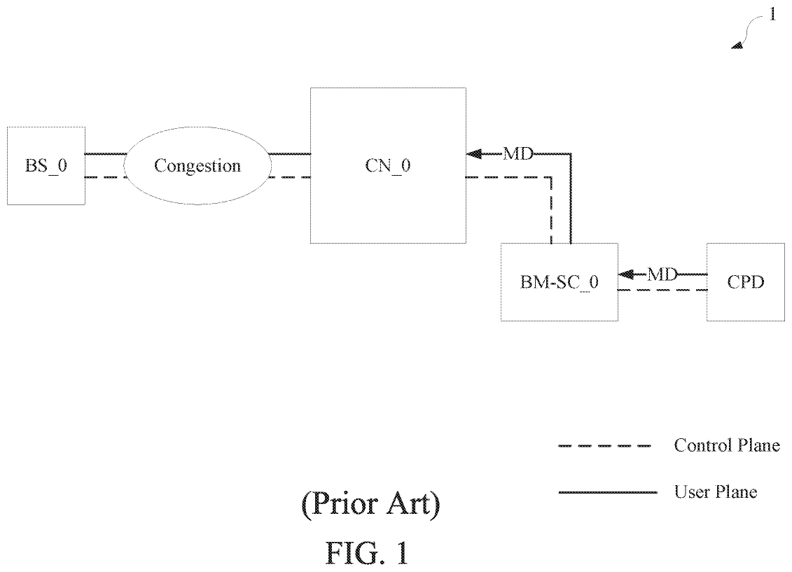

FIG. 2 illustrates a schematic view of a wireless communication system according to one or more embodiments of the present invention.

FIG. 3A illustrates a schematic view of how the wireless communication system shown in FIG. 2 redirects MBMS data according to one or more embodiments of the present invention.

FIG. 3B illustrates a schematic view of how the wireless communication system shown in FIG. 2 resume the original path of transmitting MBMS data according to one or more embodiments of the present invention.

FIG. 4 illustrates a schematic view of how the wireless communication system shown in FIG. 2 redirects the MBMS data according to one or more other embodiments of the present invention.

FIG. 5 illustrates a schematic view of another wireless communication system according to one or more embodiments of the present invention.

FIG. 6 illustrates a schematic view of how the wireless communication system shown in FIG. 5 redirects MBMS data according to one or more embodiments of the present invention.

FIG. 7 illustrates a schematic view of a method for redirecting MBMS data in a wireless communication system according to one or more embodiments of the present invention.

### DETAILED DESCRIPTION

The exemplary embodiments described below are not intended to limit the present invention to any specific environment, applications, structures, embodiments, examples, processes or steps as described in these embodiments. In the attached figures, elements not directly related to the present invention are omitted from depiction. In the attached figures, dimensional relationships among individual elements in the attached drawings are merely examples but not to limit the actual scale. Unless otherwise described, the same (or similar) element symbols may correspond to the same (or similar) elements in the following description. Unless otherwise described, the number of each element described below may be one or more under implementable circumstances.

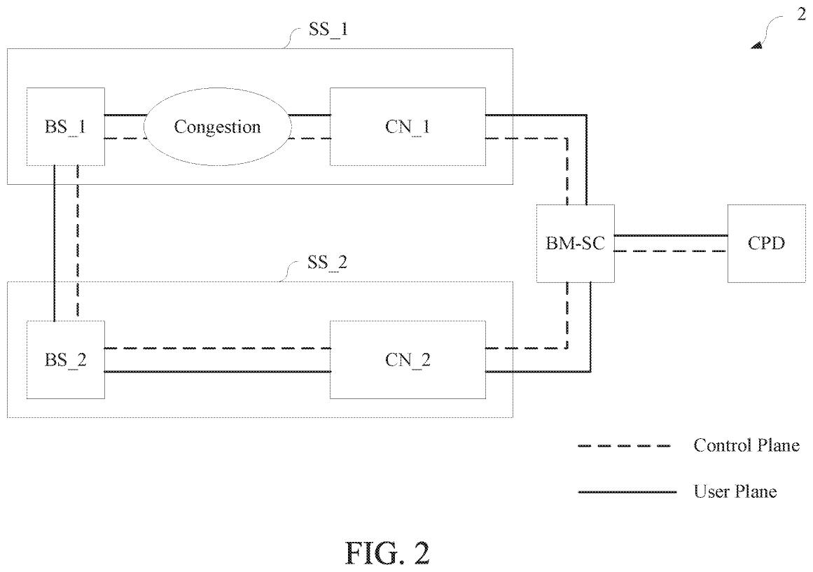

FIG. 2 illustrates a schematic view of a wireless communication system according to one or more embodiments of the present invention. However, contents of FIG. 2 are presented merely for explaining the embodiments of the present invention, but not to limit the present invention.

Referring to FIG. 2, a wireless communication system 2 may basically comprise a content provider CPD, a broadcast/multicast service center BM-SC, a first MBMS subsystem SS_1 and a second MBMS subsystem SS_2. The broadcast/multicast service center BM-SC may be coupled with each of the content provider CPD, the first MBMS subsystem SS_1 and the second MBMS subsystem SS_2. The first MBMS subsystem SS_1 may comprise a first MBMS core network CN_1 and a first base station BS_1, wherein the first MBMS core network CN_1 and the first base station BS_1 are coupled with each other. Similarly, the second MBMS subsystem SS_2 may comprise a second MBMS core network CN_2 and a second base station BS_2, wherein the second MBMS core network CN_2 and the second base station BS_2 are coupled with each other.

Depending on various requirements, the first MBMS subsystem SS_1 and the second MBMS subsystem SS_2 may be configured under the same or different mobile communication system architectures. For example, both of the first MBMS subsystem SS_1 and the second MBMS subsystem SS_2 may configured under the 4G mobile communication system architecture or 5G mobile communication system architecture. Alternatively, one of the first MBMS subsystem SS_1 and the second MBMS subsystem SS_2 is configured under the 4G mobile communication system architecture and the other is configured under the 5G mobile communication system architecture. Under the 4G mobile communication system architecture, the first MBMS subsystem SS_1 and the second MBMS subsystem SS_2 each may basically comprise a 4G MBMS gateway, a mobility management entity (MME) and a 4G MBMS coordination entity (MCE, sometimes also referred to as the multi-cell/multicast coordination entity). Under the 5G mobile communication system architecture, the first MBMS subsystem SS_1 and the second MBMS subsystem SS_2 each may basically comprise a 5G MBMS gateway, an access and mobility management function (AMF) and a 5G MBMS coordination entity. The first MBMS subsystem SS_1 and the second MBMS subsystem SS_2 may share the broadcast/multicast service center BM-SC which is configured to serve for both of them.

There may be a control plane signaling path between the content provider CPD and the first base station BS_1 through the broadcast/multicast service center BM-SC and the first MBMS core network CN_1 for transmitting MBMS control signals on it. There may be another control plane signaling path between the content provider CPD and the first base station BS_1 through the broadcast/multicast service center BM-SC, the second MBMS core network CN_2 and the second base station BS_2 for transmitting MBMS control signals on it. Similarly, there may be a user plane path (hereinafter referred to as “the first user plane path”) between the content provider CPD and the first base station BS_1 through the broadcast/multicast service center BM-SC and the first MBMS core network CN_1 for transmitting MBMS data from the content provider CPD to the base station BS_1. There may be another user plane path (hereinafter referred to as “the second user plane path”) between the content provider CPD and the first base station BS_1 through the broadcast/multicast service center BM-SC, the second MBMS core network CN_2 and the second base station BS_2 for transmitting MBMS data from the content provider CPD to the base station BS_2. The second user plane path can be also used for transmitting MBMS data to the base station BS_1 when traffic congestion is observed in the first user plane path.

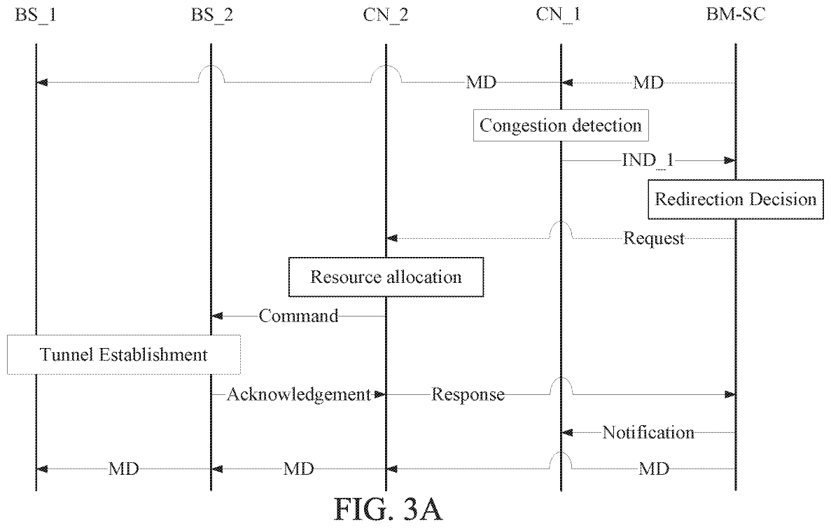

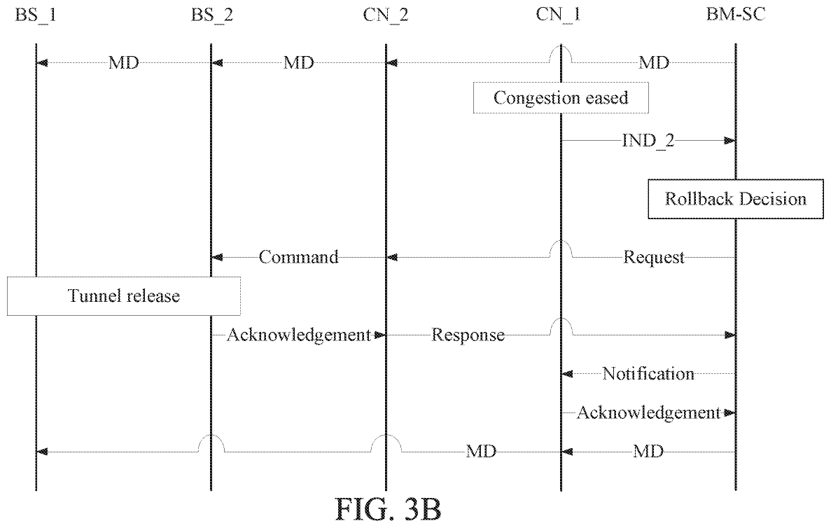

FIG. 3A illustrates a schematic view of how the wireless communication system 2 shown in FIG. 2 redirects MBMS data according to one or more embodiments of the present invention. However, contents of FIG. 3A are presented merely for explaining the embodiments of the present invention, but not to limit the present invention.

Referring to FIG. 2 and FIG. 3A, before a traffic congestion takes place on the first user plane path, for example, on the user plane between the first MBMS core network CN_1 and the first base station BS_1, the MBMS data MD of the content provider CPD can be transmitted to the first base station BS_1 via the first MBMS core network CN_1. If the first MBMS core network CN_1 detects the traffic congestion, it may send a congestion indication message IND_1 to the broadcast/multicast service center BM-SC to inform the broadcast/multicast service center BM-SC of the traffic congestion and related information. In this case, the congestion indication message IND_1 may comprise the identity of the first base station BS_1 and the related MBMS session that affected by the traffic congestion. In another case where multiple traffic congestions exist between the first MBMS core network CN_1 and multiple base stations, the first MBMS core network CN_1 may send a congestion indication message IND_1 which comprises a list of identities of the base stations and related MBMS sessions that affected by the traffic congestions. Upon receipt of the congestion indication message IND_1, the broadcast/multicast service center BM-SC may decide whether to redirect the MBMS session(s) to the second MBMS subsystem SS_2.

When the broadcast/multicast service center BM-SC decides to redirect the MBMS session(s), it may send a redirection request message to the second MBMS core network CN_2 of the second MBMS subsystem SS_2. In this case, the redirection request message may carry the identity of the first base station BS_1 and the related MBMS session that affected by the traffic congestion. In another case where the congestion indication message IND_1 comprises a list of identities of multiple base stations and related MBMS sessions, the broadcast/multicast service center BM-SC may determine which MBMS section(s) will be redirected to the second MBMS subsystem SS_2 according to various factors such as transmission urgency and the workload of the second MBMS subsystem SS_2, and therefore, the redirection request message may carry one, some or all of the multiple identities of base stations and one, some or all of the related MBMS sessions, respectively.

Upon receipt of the redirection request message, the second MBMS core network CN_2 may allocate resources for each redirection. In this case, the second MBMS core network CN_2 may allocate resources for the upcoming redirection associated with the first base station BS_1, and then select the second base station BS_2 as the forwarding node of the first base station BS_1 by sending a redirection command message to the second base station BS_2. In this case, the redirection command message may comprise the identities of the first base station BS_1 and the related MBMS session. In another case where the redirection request message comprises multiple identities of base stations and related MBMS sessions, the second MBMS core network CN_2 may determine which base stations of the first MBMS subsystem SS_1 will be served by the second base station BS_2 according to various factors such as transmission urgency and the workload of the second base station BS_2, and therefore, the redirection command message may carry one, some or all of the multiple identities of base stations and one, some or all of the related MBMS sessions, respectively.

Upon receipt of the redirection command message, the second base station BS_2 may establish an MBMS tunnel with the first base station BS_1 for forwarding the MBMS data MD after providing the related MBMS session to the first base station BS_1. After the MBMS tunnel is established, the second base station BS_2 may send a redirection acknowledgement message to the second MBMS core network CN_2 in response to the redirection command message received therefrom, and then the second MBMS core network may send a redirection response message to the broadcast/multicast service center BM-SC in response to the redirection request message received therefrom. Then, the broadcast/multicast service center BM-SC may send a redirection notification message to the first MBMS core network CN_1 indicating that the second MBMS subsystem SS_2 is ready for forwarding the MBMS data MD to the first base station BS_1 instead of the first MBMS subsystem SS_1. In this case, each of the redirection acknowledgement message, the redirection response message and the redirection notification message may comprise the identity of the first base station BS_1 and the related MBMS session. In another case where the redirection request message or the redirection command message comprises multiple identities of base stations and related MBMS sessions, each of the redirection acknowledgement message, the redirection response message and the redirection notification message may comprise a list of identities of base stations and related MBMS session that have been successfully redirected.

In this case, after transmitting the redirection notification message, the broadcast/multicast service center BM-SC may transmit the MBMS data MD associated with the redirected MBMS session to the second base station BS_2 via the second MBMS core network CN_2, so that the second base station BS_2 may forward the MBMS data MD to the first base station BS_1 in a unicast way, i.e., transmitting the MBMS data MD to the first base station BS_1 via the established MBMS tunnel. Similarly, the broadcast/multicast service center BM-SC may transmit the MBMS data associated with the other redirected MBMS sessions to the second base station BS_2 via the second MBMS core network CN_2, so that the second base station BS_2 may forward the MBMS data to each of other base stations of the first MBMS subsystem SS_1 in the same unicast way

FIG. 3B illustrates a schematic view of how the wireless communication system 2 shown in FIG. 2 resume the original path of transmitting MBMS data according to one or more embodiments of the present invention. However, contents of FIG. 3B are presented merely for explaining the embodiments of the present invention, but not to limit the present invention.

Referring to FIG. 2 and FIG. 3B, when the first MBMS core network CN_1 detects the traffic congestion on the first user plane path is eased or overcome, it may send a congestion-eased indication message IND_2 to the broadcast/multicast service center BM-SC. In this case, the congestion-eased indication message IND_2 may comprise the identity of the first base station BS_1 and related MBMS session that need to be redirected back (also known as “rollback”) to the first MBMS subsystem SS_1. In other case, the congestion-eased indication message IND_2 may comprise a list of identities of multiple base stations and related MBMS sessions that may be redirected back (also known as “rollback”) to the first MBMS subsystem SS_1. Upon receipt of the congestion-eased indication message IND_2, the broadcast/multicast service center BM-SC may decide whether to redirect back the MBMS session(s) that has previously been redirected to the second MBMS subsystems SS_2.

When the broadcast/multicast service center BM-SC determined the MBMS session(s) to be rollbacked, it may send a rollback request message to the second MBMS core network CN_2 of the second MBMS subsystem SS_2. The redirection request message may comprise one or more identities of concerned base stations including the first base station BS_1 and related MBMS session(s). Upon receipt of the rollback request message, the second MBMS core network CN_2 may send a rollback command message to the second base station BS_2. The rollback command message may comprise one or more identities of concerned base station including the first base station BS_1 and related MBMS session(s).

After receiving the rollback command message, the second base station BS_2 may perform an MBMS-tunnel release process with the first base station BS_1. The second base station BS_2 may send a rollback acknowledgement message to the second MBMS core network CN_2 in response to the rollback command message, and then the second MBMS core network CN_2 may send a rollback response message to the broadcast/multicast service center BM-SC in response to the rollback request message received therefrom. Then, the broadcast/multicast service center BM-SC may send a rollback notification message to the first MBMS core network CN_1 indicating that the second MBMS subsystem SS_2 has stopped forwarding the MBMS data MD to the first base station BS_1. Each of the rollback acknowledgement message, the rollback response message and the rollback notification message may comprise one or more identities of concerned base stations including the first base station BS_1 and related MBMS session(s) that have been successfully rolled back.

After transmitting the rollback notification message, the broadcast/multicast service center BM-SC may resume transmitting MBMS data MD to the concerned base station(s) via the first MBMS core network CN_1. In this case, the broadcast/multicast service center BM-SC may resume transmitting the MBMS data MD to the first base station BS_1 via the first MBMS core network CN_1.

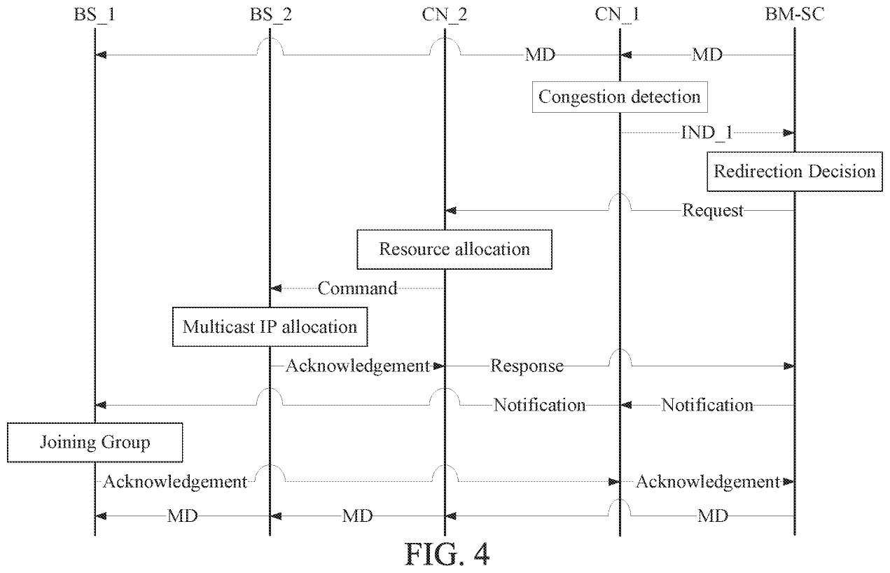

FIG. 4 illustrates a schematic view of how the wireless communication system shown 2 in FIG. 2 redirects the MBMS data according to one or more other embodiments of the present invention. However, contents of FIG. 4 are presented merely for explaining the embodiments of the present invention, but not to limit the present invention. The contents of FIG. 4 is similar to those of FIG. 3A, but that the second base station BS_2 is configured to forward the MBMS data MD to the first base station BS_1 in a multicast way instead of in an unicast way. Therefore, unless otherwise described, the contents of FIG. 4 can be understood as those of FIG. 3A.

Referring to FIG. 2 and FIG. 4, when the broadcast/multicast service center BM-SC decides to redirect the MBMS session associated with the first base station BS_1, it may send a redirection request message to the second MBMS core network CN_2 of the second MBMS subsystem SS_2. Upon receipt of the redirection request message, the second MBMS core network CN_2 may allocate resources for the redirection and send a redirection command message to the second base station BS_2. Upon receipt of the redirection command message, the second base station BS_2 may create an MBMS multicast group and allocate a multicast internet protocol address (multicast IP address) associated with the MBMS multicast group for the first base station BS_1. Then, the second base station BS_2 may send a redirection acknowledgement message carrying the multicast IP address to the second MBMS core network CN_2 in response to the redirection command message received therefrom. Next, the second MBMS core network CN_2 may send a redirection response message carrying the multicast IP address to the broadcast/multicast service center BM-SC in response to the redirection request message received therefrom. Subsequently, the broadcast/multicast service center BM-SC may send a redirection notification message carrying the multicast IP address to the first base station BS_1 through the first MBMS core network CN_1. In addition to the multicast IP address, each of the redirection acknowledgement message, the redirection response message and the redirection notification message may also carry the identity of the first base station BS_1 and the related MBMS session.

After receiving the redirection notification message, the first base station BS_1 may join the MBMS multicast group according to the multicast IP address, and then send an redirection acknowledgement message to the broadcast/multicast service center BM-SC via the first MBMS core network CN_1 to indicate that the first base station BS_1 has joined the MBMS multicast group. Next, the second base station BS_2 may forward the MBMS data MD received from the broadcast/multicast service center BM-SC through the second MBMS core network CN_2 to the first base station BS_1 in a multicast way, i.e., transmitting the MBMS data MD to the MBMS multicast group whose members includes the first base station BS_1.

In this case, when the traffic congestion on the first user plane path is eased or overcome, the wireless communication system 2 may also perform a rollback procedure as similar as the contents shown in FIG. 3B. More specifically, when the first MBMS core network CN_1 detects the traffic congestion on the first user plane path is eased or overcome, it may send a congestion-eased indication message IND_2 to the broadcast/multicast service center BM-SC. The congestion-eased indication message IND_2 may comprise a list of identities of multiple base stations and related MBMS sessions that may be rollbacked to the first MBMS subsystem SS_1. Upon receipt of the congestion-eased indication message IND_2, the broadcast/multicast service center BM-SC may decide whether to rollback the MBMS session(s) that has previously been redirected to the second MBMS subsystems SS_2.

When the broadcast/multicast service center BM-SC decides to rollback part of or all of the MBMS session(s) that has previously been redirected to the second MBMS subsystems SS_2, it may send a rollback request message to the second MBMS core network CN_2 of the second MBMS subsystem SS_2. Upon receipt of the rollback request message, the second MBMS core network CN_2 may send a rollback command message to the second base station BS_2.

After receiving the rollback command message, the second base station BS_2 may release the multicast IP address and send a rollback acknowledgement message to the second MBMS core network CN_2 in response to the rollback command message received therefrom. Next, the second MBMS core network may send a rollback response message to the broadcast/multicast service center BM-SC in response to the rollback request message received therefrom. Then, the broadcast/multicast service center BM-SC may send a rollback notification message to the first base station BS_1 via the first MBMS core network CN_1 to ask the first base station BS_1 to quit the MBMS multicast group. The first base station BS_1 may send an acknowledgement message to the broadcast/multicast service center BM-SC via the first MBMS core network CN_1. Accordingly, the broadcast/multicast service center BM-SC may resume transmitting the MBMS data MD to the first base station BS_1 via the first MBMS core network CN_1.

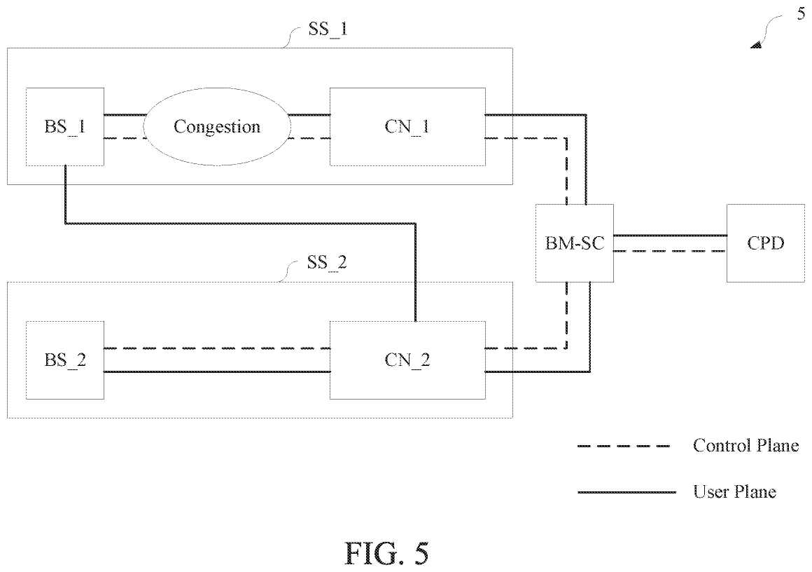

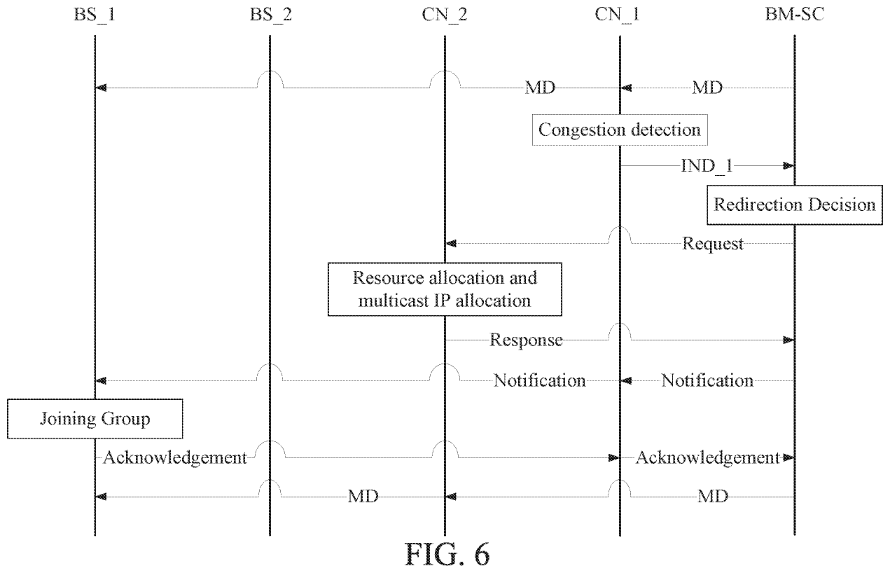

FIG. 5 illustrates a schematic view of another wireless communication system according to one or more embodiments of the present invention, and FIG. 6 illustrates a schematic view of how the wireless communication system shown in FIG. 5 redirects MBMS data according to one or more embodiments of the present invention. However, contents of FIG. 5 and FIG. 6 are presented merely for explaining the embodiments of the present invention, but not to limit the present invention.

The contents of FIG. 5 is similar to those of FIG. 2. However, the control plane and the user plane between the first base station BS_1 and the second base station BS_2 are not necessary, and there is a user plane between the first base station BS_1 and the second MBMS core network CN_2. Therefore, unless otherwise described, the contents of FIG. 5 can be understood as those of FIG. 2. In addition, the contents of FIG. 6 is similar to those of FIG. 4, but that the second MBMS core network CN_2 itself is configured to forward the MBMS data MD to the first base station BS_1 in a multicast way instead of the second base station BS_2. Therefore, unless otherwise described, the contents of FIG. 6 can be understood as those of FIG. 3A or FIG. 4.

Referring to FIG. 5 and FIG. 6, when the broadcast/multicast service center BM-SC decides to redirecting the MBMS session associated with the first base station BS_1, it may send a redirection request message to the second MBMS core network CN_2 of the second MBMS subsystem SS_2. Upon receipt of the redirection request message, the second MBMS core network CN_2 may allocate resources for the redirection. In addition, the second MBMS core network CN_2 itself may create an MBMS multicast group and allocate a multicast IP address associated with the MBMS multicast group for the first base station BS_1. Then, the second MBMS core network CN_2 itself may send a redirection response message carrying the multicast IP address to the broadcast/multicast service center BM-SC in response to the redirection request message received therefrom. Subsequently, the broadcast/multicast service center BM-SC may send a redirection notification message carrying the multicast IP address to the first base station BS_1 through the first MBMS core network CN_1. In addition to the multicast IP address, each of the redirection response message and the redirection notification message may also carry the identity of the first base station BS_1 and the related MBMS session.

After receiving the redirection notification message, the first base station BS_1 may join the MBMS multicast group according to the multicast IP address, and then send an redirection acknowledgement message to the broadcast/multicast service center BM-SC via the first MBMS core network CN_1 to indicate that the first base station BS_1 has joined the MBMS multicast group. Next, the second MBMS core network CN_2 itself may forward the MBMS data MD received from the broadcast/multicast service center BM-SC to the first base station BS_1 in a multicast way, i.e., transmitting the MBMS data MD to the MBMS multicast group whose members includes the first base station BS_1.

In this case, when the traffic congestion on the first user plane path is eased or overcome, the wireless communication system 5 may also perform a rollback procedure as similar as the contents shown in FIG. 3B. More specifically, when the first MBMS core network CN_1 detects the traffic congestion on the first user plane path is eased or overcome, it may send a congestion-eased indication message IND_2 to the broadcast/multicast service center BM-SC. Upon receipt of the congestion-eased indication message IND_2, the broadcast/multicast service center BM-SC may decide whether to rollback the MBMS session(s) that has previously been redirected to the second MBMS subsystems SS_2.

When the broadcast/multicast service center BM-SC decides to rollback part of or all of the MBMS session(s) that has previously been redirected to the second MBMS subsystems SS_2, it may send a rollback request message to the second MBMS core network CN_2 of the second MBMS subsystem SS_2. Upon receipt of the rollback command message, the second MBMS core network CN_2 may release the multicast IP address and send a rollback response message to the broadcast/multicast service center BM-SC in response to the rollback request message received therefrom. Then, the broadcast/multicast service center BM-SC may send a rollback notification message to the first base station BS_1 via the first MBMS core network CN_1 to ask the first base station BS_1 to quit the MBMS multicast group. The first base station BS_1 may send an acknowledgement message to the broadcast/multicast service center BM-SC via the first MBMS core network CN_1. Accordingly, the broadcast/multicast service center BM-SC may resume transmitting the MBMS data MD to the first base station BS_1 via the first MBMS core network CN_1.

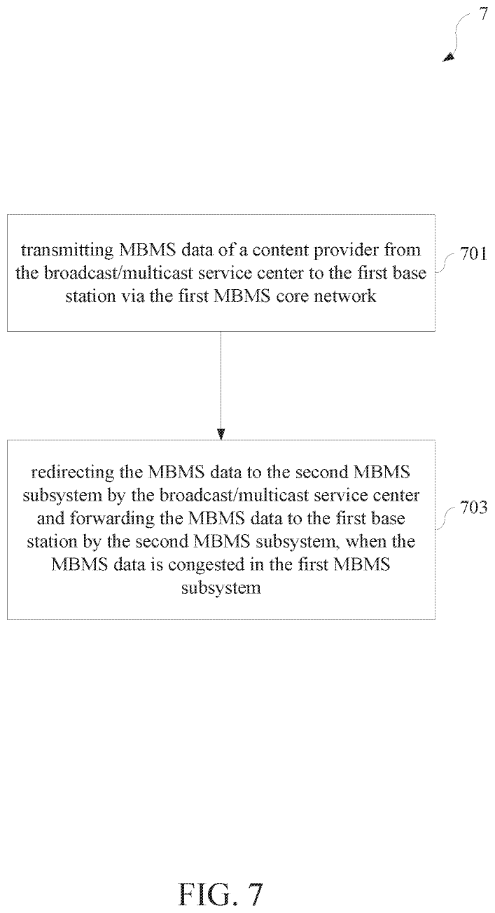

FIG. 7 illustrates a schematic view of a method for redirecting MBMS data in a wireless communication system according to one or more embodiments of the present invention. However, contents of FIG. 7 are presented merely for explaining the embodiments of the present invention, but not to limit the present invention.

Referring to FIG. 7, a method 7 for redirecting multimedia broadcast/multicast service (MBMS) data in a wireless communication system is disclosed. The wireless communication system may comprise a broadcast/multicast service center, a first multimedia broadcast/multicast service (MBMS) subsystem comprising a first base station and a first MBMS core network, and a second MBMS subsystem comprising a second base station and a second MBMS core network. The method 7 may comprise the following steps:

transmitting MBMS data of a content provider from the broadcast/multicast service center to the first base station via the first MBMS core network (marked as step 701); and

redirecting the MBMS data to the second MBMS subsystem by the broadcast/multicast service center and forwarding the MBMS data to the first base station by the second MBMS subsystem, when the MBMS data is congested in the first MBMS subsystem (marked as step 703).

In some embodiments, forwarding the MBMS data to the first base station in the method 7 may comprise forwarding the MBMS data to the first base station by the second base station in an unicast way or a multicast way.

In some embodiments, forwarding the MBMS data to the first base station in the method 7 may comprise forwarding the MBMS data to the first base station by the second MBMS core network in a multicast way.

In some embodiments, the broadcast/multicast service center may redirect the MBMS data according to a congestion indication message received from the first MBMS subsystem in the method 7.

In some embodiments, the method 7 may further comprise the step of resuming transmitting MBMS data of the content provider from the broadcast/multicast service center to the first base station via the first MBMS core network when congestion of the MBMS data eases in the first MBMS subsystem.

In some embodiments, the broadcast/multicast service center may resume transmitting MBMS data of the content provider from the broadcast/multicast service center to the first base station via the first MBMS core network according to a congestion eased message received from the first MBMS subsystem in the method 7.

In addition to the aforesaid steps, in some embodiments, the method 7 may further comprise other steps corresponding to the operations of the wireless communication system 2 and the wireless communication system 5 as mentioned above. Because the steps which are not mentioned specifically can be directly understood by people having ordinary skill in the art based on the aforesaid descriptions for the wireless communication system 2 and the wireless communication system 5, they will not be further described herein.

The above disclosure is related to the detailed technical contents and inventive features thereof. People of ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A wireless communication system, comprising:
a broadcast/multicast service center coupled with a content provider;
a first multimedia broadcast/multicast service (MBMS) subsystem, comprising a first MBMS core network coupled with the broadcast/multicast service and a first base station coupled with the first MBMS core network; and
a second MBMS subsystem, comprising a second MBMS core network coupled with the broadcast/multicast service and a second base station coupled with the second MBMS core network;
wherein the broadcast/multicast service center is configured to redirect MBMS data of the content provider which is transmitted from the broadcast/multicast service center to the first base station via the first MBMS core network to the second MBMS subsystem and the second MBMS subsystem is configured to forward the MBMS data to the first base station, when the first MBMS subsystem is in congestion.

2. The wireless communication system of claim 1, wherein the second base station is configured to forward the MBMS data to the first base station in an unicast way or a multicast way.

3. The wireless communication system of claim 1, wherein the second MBMS core network is configured to forward the MBMS data to the first base station in a multicast way.

4. The wireless communication system of claim 1, wherein the broadcast/multicast service center redirects the MBMS data according to a congestion indication message received from the first MBMS subsystem.

5. The wireless communication system of claim 1, wherein the broadcast/multicast service center is configured to resume transmitting MBMS data of the content provider to the first base station via the first MBMS core network when congestion in the first MBMS subsystem is eased.

6. The wireless communication system of claim 5, wherein the broadcast/multicast service center resume transmitting MBMS data of the content provider to the first base station via the first MBMS core network according to a congestion eased message received from the first MBMS subsystem.

7. A method for redirecting multimedia broadcast/multicast service (MBMS) data in a wireless communication system, the wireless communication system comprising a broadcast/multicast service center, a first multimedia broadcast/multicast service (MBMS) subsystem and a second MBMS subsystem, the first MBMS subsystem comprising a first base station and a first MBMS core network, the second MBMS subsystem comprising a second base station and a second MBMS core network, the method comprising:
transmitting MBMS data of a content provider from the broadcast/multicast service center to the first base station via the first MBMS core network; and
redirecting the MBMS data to the second MBMS subsystem by the broadcast/multicast service center and forwarding the MBMS data to the first base station by the second MBMS subsystem, when the first MBMS subsystem is in congestion.

8. The method of claim 7, wherein forwarding the MBMS data to the first base station comprising forwarding the MBMS data to the first base station by the second base station in an unicast way or a multicast way.

9. The method of claim 7, wherein forwarding the MBMS data to the first base station comprising forwarding the MBMS data to the first base station by the second MBMS core network in a multicast way.

10. The method of claim 7, wherein the broadcast/multicast service center redirects the MBMS data according to a congestion indication message received from the first MBMS subsystem.

11. The method of claim 7, further comprising:
resuming transmitting MBMS data of the content provider from the broadcast/multicast service center to the first base station via the first MBMS core network when congestion in the first MBMS subsystem is eased.

12. The method of claim 11, wherein the broadcast/multicast service center resume transmitting MBMS data of the content provider from the broadcast/multicast service center to the first base station via the first MBMS core network according to a congestion eased message received from the first MBMS subsystem.
